(19) United States
(12) Patent Application Publication
(10) Pub. No.: US 2006/0057355 A1
(43) Pub. Date: Mar. 16, 2006

(54) Nanoparticles-containing composite porous body and method of making the porous body

(75) Inventors: Masa-aki Suzuki, Osaka-shi (JP); Takashi Hashida, Osaka-shi (JP); Yuji Kudoh, Kyoto-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Matsushita Electric Industrial Co., Ltd.

(21) Appl. No.: 11/251,749

(22) Filed: Oct. 17, 2005

Related U.S. Application Data
(63) Continuation of application No. PCT/JP04/07424, filed on May 24, 2004.

(30) Foreign Application Priority Data
Jun. 12, 2003 (JP) 2003-167885

(51) Int. Cl. B32B 5/14; B32B 9/00

(52) U.S. Cl. 428/308.4; 428/408; 428/318.4; 264/41; 264/29.1

(57) ABSTRACT

A nanoparticles-containing composite porous body according to the present invention includes a porous body having a solid skeleton and pores and nanoparticles of an inorganic substance. The nanoparticles are carried on the solid skeleton without coagulating together or being chemically bonded to the skeleton. The nanoparticles may be coated with organic aggregates and carried as composite particles on the solid skeleton. As the organic aggregates, spherical organic aggregates such as a spherical protein or a dendrimer are preferably used. Also, the organic aggregates may be decomposed and removed if necessary.

This is a continuation of International Application PCT/JP2004/007424, with an international filing date of May 24, 2004.

### BACKGROUND OF THE INVENTION

1. Field of the Invention

The present invention relates to a composite porous body containing nanoparticles and a method of making such a porous body. The nanoparticles-containing composite porous body of the present invention can be used effectively in a catalyst carrier such as a filter, a gas adsorbent or a deodorant, an electrochemical element such as a cell or a chemical sensor, and an optical element such as a fluophor or an optical modulator by taking advantage of the features of those nanoparticles.

2. Description of the Related Art

A nanoparticle, which is a very small particle of a nanometer scale, has a geometric high specific surface and is expected to express a quantum size effect. Thus, this material is expected to achieve new functions, which cannot be achieved by any bulk material, by improving the chemical and physical conversion properties in catalytic reactions and luminescence, for example.

When applied to a device, such nanoparticles need to be carried on a supporting body. As the supporting body, a supporting body having a porous structure (which will be referred to herein as a “porous body”) such as a honeycomb structure, a fiber assembly or a particle assembly is preferably used to utilize the high specific surface of the nanoparticles and to produce highly efficient reactions. Also, a porous body carrying nanoparticles can be obtained by either mixing the material of the porous body with nanoparticles or material particles (i.e., precursor particles) or impregnating the porous body with a solution containing nanoparticles or material particles.

According to such a method, however, the nanoparticles may coagulate together to possibly decrease the original activity of the nanoparticles or the efficiency of a device using those particles. That is why to take advantage of the features of the nanoparticles, a method for dispersing the nanoparticles homogeneously is needed. And various methods have been developed to achieve that purpose. In a catalyst used for electrode reactions, in particular, catalyst particles of a nanometer scale need to be formed homogenously at the best concentration without allowing them to coagulate together in order to achieve high efficiency in as small an amount as possible. For that purpose, techniques of forming and dispersing nanometer-scale catalyst particles by controlling the structure of its carrier have been researched. For example, Japanese Patent Application Laid-Open Publication No. 2002-159851 discloses a method for controlling the structure of a carrier by using a carbon nanohorn and reducing the catalyst forming size due to its geometric structure. On the other hand, Japanese Patent Application Laid-Open Publication No. 2000-012041 discloses a method for reducing the catalyst forming size geometrically by using pores, which are made when the surface of a carbon carrier is coated with a solid polymer electrolyte. Furthermore, a method of subjecting nanoparticles produced to a surface treatment in advance to avoid their coagulation and a method of dispersing the particles and preventing them from coagulating into a porous body by using a highly diffusive solvent are disclosed by Y. Tai, M. Watanabe, K. Kaneko, S. Tanemura, T. Miki, J. Murakami and K. Tajiri in Advanced Materials, Vol. 13, No. 21, pp. 1611-1614 (2001) and Japanese Patent Application Laid-Open Publication No. 2001-089129.

As methods for making nanoparticles with uniform particle sizes, a method of synthesizing them in a solution such as a colloid and a method that adopts a dry process such as heating in a vacuum or a laser ablation are known. Also, a method of forming nanoparticles in an organic compound with a specified structure in order to obtain nanoparticles with uniform particle sizes has been researched. For example, methods that use ferritin as a protein are disclosed in Japanese Patent Application Laid-Open Publications Nos. 11-045990 and 11-204774. A method that uses a dendrimer polymer is disclosed in PCT International Application Publication No. WO 98/30604 (corresponding to Japanese National Phase Publication 2001-508484), the entire disclosure of which is hereby incorporated by reference.

As described above, to make full use of the high-activity properties of nanoparticles, the technique of carrying those particles on a supporting body without coagulating them is important. For that purpose, methods for dispersing catalyst particles, for example, homogenously without coagulating them have been researched a lot. However, those methods have been researched just step by step every time a new application is developed. Thus, to further improve the performance, a whole new technique needs to be developed.

In the technique of forming and dispersing nanometer-scale catalyst particles by controlling the structure of its carrier, the structure of the carrier as the supporting body needs to be developed according to its purpose of use. Also, the technique of dispersing the nanoparticles produced and preventing them from coagulating into a porous body by subjecting the particles to a surface treatment in advance also prevents the nanoparticles being produced from coagulating, too. As to a gold colloid, for example, a method for preventing colloidal particles from coagulating by providing a protective coating on the surface of the particles is known. In the Y. Tai at al.'s document identified above, gold nanoparticles to which a protective coating has been adsorbed are used. In optical or electrical applications in which the overall solid properties of the nanoparticles are used, this protective coating causes no serious problems. However, in other applications in which the surface of the nanoparticles is used (e.g., when the nanoparticles are used as a catalyst or an adsorbent), the presence of this protective coating causes a decrease in efficiency. To avoid such a problem, the protective coating may be removed while the nanoparticles are being carried. Nevertheless, in a conventional ionic electrostatic protective coating or a surfactant adsorbed protective coating, the effects are achieved by making the protective coating partially coat the nanoparticles. Thus, when the protective coating is removed, adjacent nanoparticles may coagulate together. Also, if a porous body is formed by mixing nanoparticles with a protective coating together, then the nanoparticles will often be included in, and covered with, the solid skeleton of the porous body. In that case, even after the protective coating has been removed, its activity may still be limited.

Furthermore, the use of the ferritin protein or dendrimer polymer was disclosed as a technique using nanoparticles with uniform particle sizes. Such a technique hopes to use the geometric effects achieved by a composite structure of an organic compound and nanoparticles. However, that technique was not disclosed as a technique of dispersing and carrying the nanoparticles in a porous body to make full use of these properties and the high activity of the nanoparticles. Japanese Patent Application Laid-Open Publication No. 4-285081 discloses a manufacturing process in which a dendrimer polymer is used as a mold for forming porous silica but is silent about the technique of carrying the nanoparticles.

### SUMMARY OF THE INVENTION

In order to overcome the problems described above, an object of the present invention is to provide a nanoparticles-containing composite porous body, which carries high-activity nanoparticles without deteriorating their properties, and a method of making such a porous body.

A nanoparticles-containing composite porous body according to a first aspect of the present invention includes: a porous body having a solid skeleton and pores; and nanoparticles of an inorganic substance. The porous body is characterized in that the nanoparticles are carried on the solid skeleton without coagulating together or being chemically bonded to the skeleton, whereby the above object is achieved.

In one preferred embodiment, the nanoparticles are carried inside the solid skeleton.

In another preferred embodiment, the nanoparticles-containing composite porous body further includes organic aggregates. The organic aggregates coat the nanoparticles, thereby making composite particles. And the nanoparticles are carried on the solid skeleton by way of the organic aggregates.

In another preferred embodiment, the organic aggregates are chemically bonded to the solid skeleton.

In another preferred embodiment, the organic aggregates have an ordered structure. For example, a dendritic polymer such as a dendrimer forms a self-organized structure.

In another preferred embodiment, the organic aggregates are spherical organic aggregates.

In another preferred embodiment, the spherical organic aggregates are a spherical protein.

In another preferred embodiment, the spherical protein is ferritin.

In another preferred embodiment, the spherical organic aggregates are dendritic polymers.

In another preferred embodiment, the dendritic polymers are dendrimers.

In another preferred embodiment, the solid skeleton of the porous body defines a network structure.

In another preferred embodiment, the porous body is a dry gel of an inorganic oxide.

In another preferred embodiment, the porous body is a carbon porous body.

A method of making a nanoparticles-containing composite porous body according to a second aspect of the present invention includes the steps of: providing composite particles that include nanoparticles of an inorganic substance and organic aggregates coating the nanoparticles; preparing a material solution to make a porous body; mixing the material solution and the composite particles together; and making the porous body, including a solid skeleton and pores, from the material solution. The porous body includes the composite particles that are dispersed, whereby the above object is achieved.

In one preferred embodiment, the method includes the steps of: providing organic aggregates; preparing a material solution to make a porous body; mixing the material solution and the organic aggregates together; making the porous body, including a solid skeleton and pores, from the material solution, the porous body including the organic aggregates that are dispersed; and forming nanoparticles inside the organic aggregates included in the porous body.

In another preferred embodiment, the method includes the steps of: providing a solution containing composite particles that include nanoparticles of an inorganic substance and organic aggregates coating the nanoparticles; preparing a porous body including a solid skeleton and pores; and impregnating the porous body with the solution, thereby making the porous body have the composite particles dispersed.

In another preferred embodiment, the method includes the steps of: providing a solution containing organic aggregates; preparing a porous body including a solid skeleton and pores; impregnating the porous body with the solution, thereby making the porous body have the organic aggregates dispersed; and forming nanoparticles inside the organic aggregates included in the porous body.

In one preferred embodiment, the porous body is formed by a sol-gel process.

In another preferred embodiment, the method further includes the step of drying the porous body.

In another preferred embodiment, the solid skeleton of the porous body is made of a carbon precursor, and the method further includes the step of forming a carbon porous body by carbonizing the carbon precursor after the step of drying has been performed.

In another preferred embodiment, the method further includes the step of decomposing the organic aggregates included in the porous body.

In another preferred embodiment, the step of decomposing includes the step of heating the organic aggregates.

In another preferred embodiment, the step of decomposing includes substantially removing the organic aggregates.

In another preferred embodiment, the step of forming the nanoparticles includes the steps of preparing a precursor of the nanoparticles and transforming the precursor into the nanoparticles.

In another preferred embodiment, the method further includes the step of decomposing the organic aggregates included in the porous body, and the step of transforming the precursor is performed in the step of decomposing the organic aggregates.

A nanoparticles-containing composite porous body according to another aspect of the present invention is characterized by being made by one of the methods described above. The nanoparticles-containing composite porous body of the first aspect can be obtained by any of the methods described above.

### BRIEF DESCRIPTION OF THE DRAWINGS

FIG. 1 schematically illustrates the structure of a nanoparticles-containing composite porous body 10 according to a preferred embodiment of the present invention.

FIG. 2 is a schematic representation illustrating how nanoparticles are carried on the nanoparticles-containing composite porous body 10.

FIG. 3 schematically illustrates the structure of a nanoparticles-containing composite porous body 20 according to another preferred embodiment of the present invention.

FIG. 4 illustrates composite particles (ferritin particles) for use in a nanoparticles-containing composite porous body according to the present invention.

FIGS. 5(a) and 5(b) illustrate other composite particles for use in a nanoparticles-containing composite porous body according to the present invention: wherein FIG. 5(a) is a schematic representation illustrating a nanoparticle composite body as a dendrimer and FIG. 5(b) is a schematic representation illustrating a dendrimer.

FIG. 6 is a schematic representation illustrating how nanoparticles are carried on a nanoparticles-containing composite porous body according to another preferred embodiment of the present invention.

FIG. 7 schematically illustrates the structure of a conventional nanoparticles-containing composite porous body.

### DETAILED DESCRIPTION OF THE INVENTION

Hereinafter, preferred embodiments of the present invention will be described.

A nanoparticles-containing composite porous body according to a preferred embodiment of the present invention includes: a porous body having a solid skeleton and pores; and nanoparticles of an inorganic substance. The nanoparticles are carried on the solid skeleton without coagulating together or being chemically bonded to the skeleton. The nanoparticles may be made of an inorganic compound or a metal, for example.

By using a porous body as a supporting body for carrying nanoparticles, the nanoparticles with a high specific surface can be arranged spatially efficiently. As a result, the nanoparticles can be used much more efficiently. In addition, it is possible to prevent the nanoparticles from coagulating together. Furthermore, since the nanoparticles are carried on the porous body without being chemically bonded to the solid skeleton of the porous body, the unique functions of the nanoparticles are not diminished but can be utilized fully.

As the porous body, a supporting body with a porous structure like a particle assembly such as a honeycomb structure, a fiber assembly, a ceramic particle sintered body may be used. Among other things, a porous body, having pores of a nanometer scale and a solid skeleton defining a network structure with a high specific surface, is preferably used. As such a porous body, a wet gel formed by a sol-gel process or a dry gel obtained by drying a wet gel may be used effectively.

### Structure of Nanoparticles-Containing Composite Porous Body

First, the structure of a nanoparticles-containing composite porous body according to a preferred embodiment of the present invention will be described with reference to the accompanying drawings.

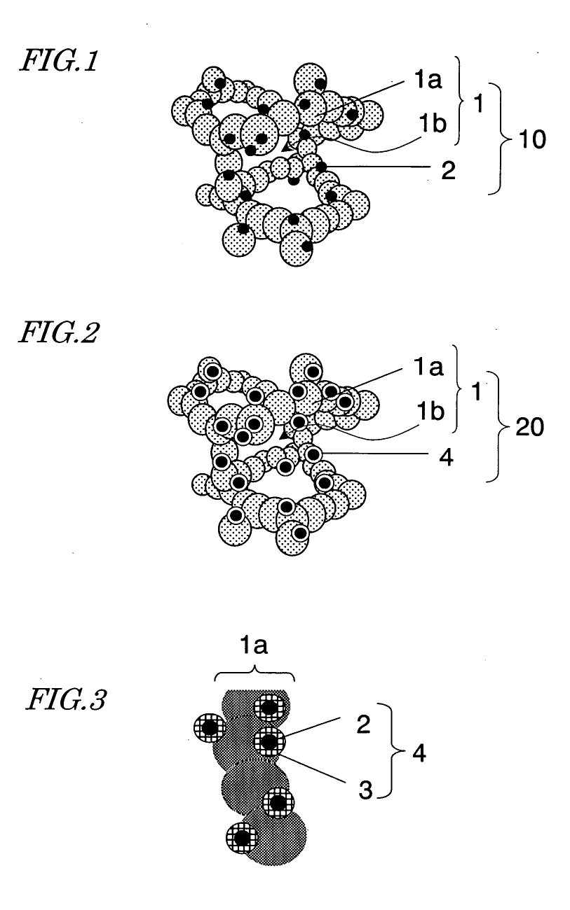

FIG. 1 schematically illustrates the structure of a nanoparticles-containing composite porous body 10 according to a preferred embodiment of the present invention. In FIG. 1, a portion of the nanoparticles-containing composite porous body 10 is shown on a larger scale.

In the nanoparticles-containing composite porous body 10, nanoparticles 2 are carried on a porous body 1, having a solid skeleton 1a and pores 1a, without coagulating together. Such a non-coagulating presence of those nanoparticles 2 will sometimes be referred to herein as “homogenous dispersion”. Also, the nanoparticles 2 are not chemically bonded to the solid skeleton 1a of the porous body 1, either.

The nanoparticles 2 in the nanoparticles-containing composite porous body 10 are carried in the homogenous dispersion state on the solid skeleton of the porous body without being chemically bonded to the skeleton. Thus, the specific surface of the nanoparticles 2 can be kept high and the decrease in activity due to the carrying can be avoided.

Hereinafter, the features of the nanoparticles-containing composite porous body 10 of this preferred embodiment will be described in comparison with the structure of the conventional nanoparticles-containing composite porous body shown in FIG. 7.

In the conventional nanoparticles-containing composite porous body shown in FIG. 7, nanoparticles 2 are also carried on the solid skeleton 1a of a porous body 1 as in the nanoparticles-containing composite porous body 10 of this preferred embodiment. However, in the conventional porous body, the nanoparticles 2 carried form coagulations 7 unlike the porous body of this preferred embodiment. Since the nanoparticles 2 form the coagulations 7, the specific surface of the nanoparticles 2 physically decreases, which is not beneficial. From a chemical point of view, the active sites of the nanoparticles 2 bond together in the coagulations 7, thus decreasing the activity, which is not beneficial, either.

In contrast, the nanoparticles-containing composite porous body 10 of this preferred embodiment shown in FIG. 1 causes none of those problems of the nanoparticles-containing composite porous body shown in FIG. 7, thus losing (almost) none of the features of the nanoparticles 2.

FIGS. 2 and 3 schematically illustrate the structure of a nanoparticles-containing composite porous body 20 according to another preferred embodiment of the present invention.

The nanoparticles-containing composite porous body 20 further includes organic aggregates 3, which coat nanoparticles 2, thereby forming composite particles 4. The nanoparticles 2 are carried on the solid skeleton 1a by way of the organic aggregates 3. Each composite particle 4 typically includes one nanoparticle 2 as shown in FIGS. 2 and 3. And those composite particles 4 are retained and dispersed over the porous body 1. That is why the nanoparticles 2 neither coagulate together nor bond to the solid skeleton 1a. To use the nanoparticles 2 efficiently, each of those composite particles 4 preferably includes one nanoparticle 2. Alternatively, one composite particle 4 may include a plurality of nanoparticles 2, too. Even so, however, those nanoparticles 2, included in one composite particle 4, need to be separated from each other by the organic aggregate 3.

If the nanoparticles 2 are dispersed as the composite particles 4, then the organic aggregate 3 is always present between each pair of nanoparticles 2 and between each nanoparticle 2 and the solid skeleton 1a. Thus, the nanoparticles 2 are separate from each other by a certain distance. When observed through an electron microscope, for example, all of those nanoparticles 2 will be seen to be dispersed as individual particles except some that look overlapping each other due to an electron beam transmitted.

By using these organic aggregates 3, not only the spacer-type effect of separating the nanoparticles 2 from each other as described above but also the following effects are achieved as well.

The organic aggregates 3 are usually transparent to a gas or a liquid and do not substantially decrease the specific surface of the nanoparticles 2. Also, the organic aggregates 3 and the nanoparticle 2 are just combined together without forming any chemical bond between them. Accordingly, when a chemical reaction with the nanoparticles 2 needs to be used, the high activity of the nanoparticles 2 can be made full use of. In addition, since the nanoparticles 2 are coated with the organic aggregates 3, the effect of preventing the nanoparticles 2 from coagulating is achieved constantly with time. That is to say, it is possible to avoid an unwanted situation where the nanoparticles 2 gradually start to coagulate together as the nanoparticles-containing composite porous body is used for a longer and longer time.

Furthermore, if the spherical organic aggregates 3 are chemically bonded to the solid skeleton 1a of the porous body 1, then the composite particles 4 are firmly supported on the solid skeleton 1a. As a result, a high-reliability nanoparticles-containing composite porous body can be provided.

It should be noted that if the organic aggregates 3 are decomposed by heating the nanoparticles-containing composite porous body 20 shown in FIG. 2, for example, the nanoparticles-containing composite porous body 10 shown in FIG. 1 can be obtained.

### Nanoparticles

Any known nanoparticles of an inorganic substance may be used as the nanoparticles 2 in the nanoparticles-containing composite porous body according to this preferred embodiment of the present invention. The inorganic substance may be a metal or an inorganic compound.

Examples of metal elements that can be used as the nanoparticles 2 include iron, zinc, aluminum, magnesium, phosphorus, manganese, nickel, cobalt, rhodium, iridium, germanium, lithium, copper, gold, silver, platinum, palladium, titanium, vanadium, tin, ruthenium, yttrium, neodymium, europium and their alloys and compounds. Any of these metals may be introduced as ions into an organic aggregate (such as ferritin or dendrimer) when dissolved in a solution, for example. However, the present invention is in no way limited to these metals.

Also, any of these metallic nanoparticles can be turned into nanoparticles of an inorganic compound. For example, a metal oxide may be obtained by conducting a heat treatment or an ozone treatment either using an oxidant or within an atmosphere including oxygen. A metal hydroxide may be obtained either by exposing the metallic nanoparticles to water or by conducting a heat treatment on the particles within an atmosphere including water. And a metal halide or sulfide may be obtained by processing the metallic nanoparticles with hydrogen halide or hydrogen sulfide. Conversely, metallic nanoparticles may also be obtained by reducing the nanoparticles of a metal oxide. The reduction process may be performed as a heat treatment within a hydrogen atmosphere or as a process that uses a methanol solution including a reducing agent such as hydrazine, sodium boron hydride or potassium boron hydride.

Furthermore, as will be described later, the nanoparticles 2 may be obtained by transforming precursor particles. In that case, a porous body is prepared so as to carry precursor particles that are dispersed, and then the precursor particles may be transformed into the nanoparticles. This process step and the process step of decomposing the organic aggregates may be carried out at the same time.

When the nanoparticles-containing composite porous body is used as a catalyst or a gas adsorbent, the nanoparticles are preferably made of an inorganic substance that has been known as having a catalytic function such as platinum, palladium, nickel, gold, platinum-palladium alloy, iron oxide, manganese oxide, titanium oxide, vanadium oxide, nickel oxide, copper oxide or zinc oxide. Then, high activity is achieved.

On the other hand, when the nanoparticles-containing composite porous body is used as a fluophor or a nonlinear optical material, the nanoparticles preferably have their properties improved by quantum size effect and may be semiconductor particles such as cadmium sulfide or zinc sulfide, an oxide containing ruthenium, an oxide containing europium, or gold.

When metallic nanoparticles are used, the nanoparticles 2 may have sizes falling within the range of zero point a few nanometers to about 100 nm, which are the sizes of a single atom. The size of the nanoparticles 2 is preferably defined such that the nanoparticles 2 have a specific surface of about 10 m²/g or more. For example, platinum nanoparticles preferably have a size of about 30 nm and palladium nanoparticles preferably have a size of about 50 nm. If the particle size were less than any of these sizes, then the specific surface would increase steeply to make the reaction activity rather high. More preferably, the size of the nanoparticles is defined such that the nanoparticles will have a specific surface of about 50 m²/g or more. For example, platinum nanoparticles preferably have a size of about 6 nm and palladium nanoparticles preferably have a size of about 10 nm. If the particle size were less than any of these sizes, then the specific surface would increase steeply to make the reaction activity rather high. In addition, the reaction activity would further increase due to the expression of the quantum size effect, for example. When nanoparticles of an inorganic compound are used, the nanoparticles 2 preferably have a size of about 100 nm or less. Then, the specific surface will increase and the reaction activity will rise. Furthermore, the nanoparticles should have a specific surface of 50 m²/g or more and a size of about several tens of nanometers or less. Then, the reaction activity will further increase.

### Organic Aggregate

As used herein, the “organic aggregate” broadly refers to any structure in which an organic substance has aggregated. Thus, the “organic aggregate” may be an aggregate of a plurality of organic molecules (which are either macromolecules or macromolecules) or an aggregate structure (high-order structure) formed by a single macromolecule. In any case, the organic aggregate preferably defines an ordered structure. If the organic aggregate has an ordered structure (such an organic aggregate with an ordered structure will sometimes be referred to herein as an “organic texture”), then the material or precursor of the nanoparticles easily enters that organic texture. This is because the organic texture has relatively big, regular gaps (passages) inside. Furthermore, the organic texture can regulate the structure of nanoparticles according to the nature of its constituent molecules. For example, if the organic texture is impregnated with a solution including metal ions, then the ions will enter the organic texture, be affected by its constituent molecules (or chemical structure), and aggregate together at predetermined sites in the organic texture, thereby forming nanoparticles of a predetermined uniform size. The composite particles formed in this manner include nanoparticles with the same structure and size. Thus, there is little variation in reaction activity, and therefore, only nanoparticles with high reaction activity can be used efficiently. Accordingly, when the nanoparticles are carried on the solid skeleton of a porous body, the same effects are achieved by a smaller amount of nanoparticles compared with using nanoparticles that have various structures and sizes. Also, an organic aggregate is usually highly transparent to a gas or a liquid. The organic texture is preferred because it has particularly high transparency. When the organic texture is used as the organic aggregate, the decrease in the activity of the nanoparticles can be minimized and the nanoparticles can be easily introduced into the organic textures using a solution, for example.

Furthermore, to make both the gap between nanoparticles included and the gap between each nanoparticle and the solid skeleton of the porous body substantially constant, the organic aggregates for use in the nanoparticles-containing composite porous body are preferably spherical organic aggregates. If those nanoparticles can be held at substantially regular gaps, then the nanoparticles being carried on the solid skeleton of the porous body will not coagulate together or lose their activity. In addition, since the nanoparticles can be arranged at nanometer-scale gaps, no coagulation state can be maintained and yet the best reaction activity is achieved, not both of which can be achieved if the nanoparticles are held at irregular gaps.

Also, the organic aggregates preferably have a functional group, which is easily chemically bonded to the solid skeleton of the porous body, as an additional external group. When the organic aggregates and the solid skeleton form a chemical bond in the resultant nanoparticles-containing composite porous body, the nanoparticles can be carried firmly and the properties of the nanoparticles-containing composite porous body can be stabilized. As such a spherical organic texture, ferritin, which is a kind of spherical protein, or a dendrimer, which is a type of dendritic polymer, is preferably used.

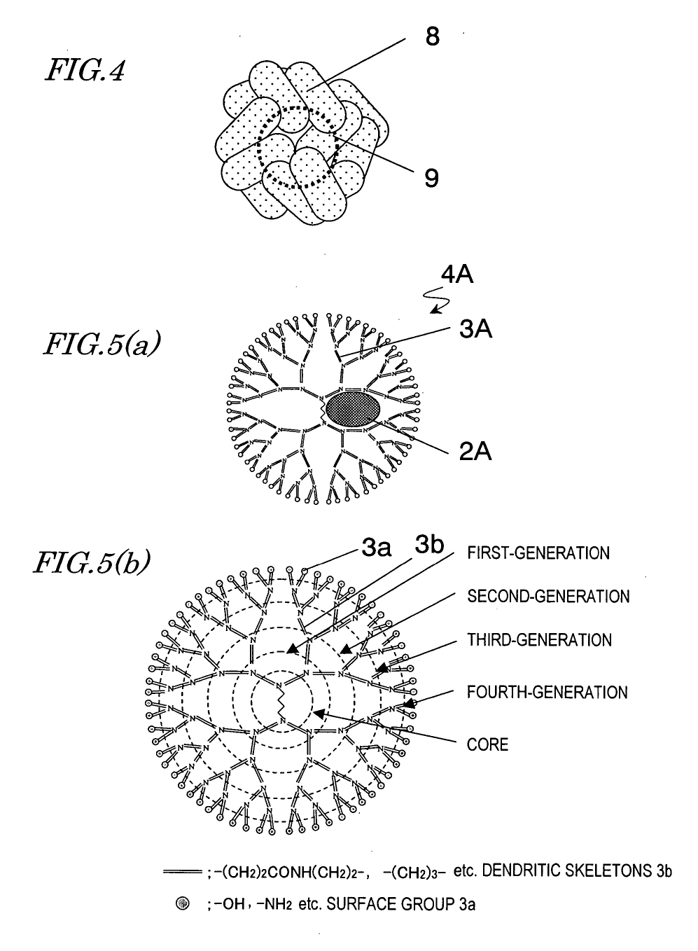

As schematically illustrated in FIG. 4, in ferritin, twenty-four subunits 8, each being made of a protein with a molecular weight of about 20,000, form a noncovalent bond, of which the core 9 has a spherical particle of iron oxide. Accordingly, ferritin itself can be called a composite particle. The ferritin particle has a diameter of about 12 nm and the iron oxide nanoparticle of the core 9 has a controlled diameter of about 6 nm. The structure of this composite particle is controlled by oxidizing ferrous ions at iron oxidization activating sites of the protein ferritin and forming crystal grains of iron oxide in negative charge regions in ferritin.

Alternatively, the composite particle may also be made of apoferritin, which is a ferritin with a vacant core. Specifically, metal ions may enter the core of ferritin and then turned into a metal nanoparticle by either transforming or reducing the metal ions into a nanoparticle of an inorganic compound such as a metal oxide, chloride, hydroxide or sulfide. The nanoparticle of each of these different inorganic compounds and metal nanoparticle have their structures (including their sizes) regulated by the vacancy at the center of apoferritin and therefore, each nanoparticle has a diameter of about 6 nm.

Also, by using a dendrimer as the organic texture, a composite particle 4A can be obtained as schematically shown in FIG. 5(a). The dendrimer is a multi-dendrite spherical polymer in which the dendrites of a polymer have been grown regularly. As schematically shown in FIG. 5(b), the dendrimer is characterized by including a core, dendritic skeletons 3b extending from the core, and a functional group (surface group) 3a bonded to the outermost dendritic skeleton 3b. Also, the dendrimer is synthesized by sequentially polymerizing the dendritic skeletons 3b from the core molecule. And the generations of the dendrimer are determined by the number of times of the polymerization.

By determining the three elements and generations of the dendrimer, the structure and size of the dendrimer can be controlled with high precision. In addition, the structure and size of the nanoparticle 2A to be introduced into the dendrimer can also be regulated as shown in FIG. 5(a).

Examples of typical dendrimers include polyamide amine-based dendrimers, polypropylene imine-based dendrimers, and polyether-based dendrimers. Aliphatic polymers, aromatic polymers and various other polymers are known. The size of the dendrimer can be controlled by adjusting the generation of growth but just need to be big enough to carry a nanoparticle inside. Specifically, the dendrimer preferably has a size of about 1 nm to about 100 nm, more preferably 1 nm to 50 nm. As to the size of the dendrimer, the lower limit is set by the size of the nanoparticle to be included and the upper limit is set so as not to inhibit the high activity and other properties of the nanoparticle. That is to say, if the size of the dendrimer exceeded 100 nm, then the properties of the nanoparticle might be inhibited or the dendrimer might prevent an external gas or liquid from reaching the nanoparticle. Also, if the dendrimer size became too big, then a very small amount of nanoparticles would be carried on the solid skeleton of the porous body, thus making it difficult to achieve high reaction activity.

FIG. 5(a) schematically illustrates the structure of a composite particle 4A, in which the nanoparticle 2A is included in the dendrimer 3A as an organic texture.

The nanoparticle 2A is formed by making a solution including metal ions, for example, enter the dendrimer 3A. The metal ions that have entered the dendrimer 3A are retained in the internal elements (i.e., the core and dendritic skeletons) by forming an ionic bond, a complex bond (coordinate bond) or a hydrogen bond with them. And these metal ions are either transformed into an inorganic compound such as an oxide, a hydroxide, a halide or a sulfide or reduced into metal atoms, thereby forming the nanoparticle 2A. The formation of this nanoparticle 2A can be controlled by adjusting the size of the dendrimer, the molecular species (of the compound that makes the core and/or the dendritic skeletons), the type of the metal ions, the concentration of the metal ions in the solution, the temperature at which the ions are made to enter the dendrimer, the time, and other parameters. Optionally, nanoparticles of a composite inorganic compound or an alloy may be formed by mixing multiple types of metal ions together.

It should be noted that the nanoparticle preferably forms no chemical bond such as a covalent bond with the organic texture to minimize the decrease in activity. In ferritin and dendrimer, the organic texture and the nanoparticle do not form any chemical bond, and therefore, the activity does not decrease easily. No chemical bond to the nanoparticle is preferred in not only the organic texture described above but also other organic aggregates as well. Furthermore, even if a chemical bond is formed, the activity may not decrease as long as the bond strength is low.

Various functional groups may be introduced as the surface group 3a of the dendrimer. For example, a functional group that reacts with, and forms a bond with, the solid skeleton of the porous body is preferably introduced because the composite particle can be bonded to the porous body firmly in that case. Examples of preferred functional groups include hydroxyl group, amino group, carboxyl group, trimethoxysilyl group, trichlorosilyl group, thiol group, dithio group, vinyl group and epoxy group. However, any other group may also be used as long as a chemical bond can be formed. Also, in ferritin, an active group on the surface of the protein contributes to chemically bonding it to the solid skeleton of the porous body.

### Porous Body

Any known porous body (such as a honeycomb structure, a fiber assembly or a particle assembly) may be used as the porous body that makes the nanoparticles-containing composite porous body according to this preferred embodiment of the present invention. Among other things, a porous body with a pore diameter of 100 nm or less is preferred because the porous body has so large a specific surface as to use the high specific surface and high activity of the nanoparticles efficiently. As such a porous body, a dry gel or a mesoporous body can be used effectively. The dry gel may be obtained by drying a wet gel that has been formed by a sol-gel process, for example. A wet gel may also be used as the porous body according to the field of application. However, the following description will be focused on the dry gel. On the other hand, the mesoporous body can be obtained by synthesizing a surfactant and an inorganic compound together, for example. A dry gel formed by a sol-gel process, in particular, has a solid skeleton defining a network structure, as well as the high specific surface, and can carry the nanoparticles three-dimensionally homogenously.

The porous body 1 shown in FIG. 1 is made of a dry gel and the solid skeleton 1a thereof defines a network structure. Such a network structure is formed by coagulating and coupling together sol fine particles in a material solution that has been prepared by a sol-gel process. When the dry gel is observed through an electron microscope, for example, it can be seen that the coagulation of those fine particles forms the solid skeleton 1a and that pores 1b are created as the gaps of the solid skeleton 1a. The fine particles forming the solid skeleton 1a typically have a diameter of 50 nm or less, while the pores typically have a diameter of 100 nm or less. By using such a dry gel, a low-density body with a pore ratio of 50% or more and a porous body with a high specific surface can be obtained. More specifically, a porous body with a specific surface of 100 m²/g or more as measured by a Brunauer-Emmett-Teller (BET) method, which is a nitrogen adsorption method, can be obtained. And even a porous body with as high a specific surface as 500 m²/g or more (i.e., a dry gel) can be obtained.

As the material of the solid skeleton of the dry gel, an inorganic material (e.g., an inorganic oxide, in particular) is preferred considering its thermal resistance and chemical stability. The material of the inorganic oxide may be a normal metal oxide. However, the material is preferably prepared by a sol-gel process to form a solid skeleton with a network structure. Examples of preferred metal oxides include silicon dioxide (silica), aluminum dioxide (alumina), titanium oxide, vanadium oxide, tantalum oxide, iron oxide, magnesium oxide, zirconium oxide and an oxide including a plurality of metal elements.

Among other things, silica, alumina and titanium oxide are particularly preferred because a wet gel can be easily formed by a sol-gel process. These inorganic oxides may be made of any materials as long as a wet gel can be formed by a sol-gel reaction. For example, an inorganic material such as sodium silicate or aluminum hydroxide or an organic material of a metalorganic alkoxide such as tetramethoxysilane, tetraethoxysilane, aluminum isopropoxide, aluminum sec-butoxide or titanium isopropoxide and a catalyst are dissolved in a solvent and subjected to a sol-gel process, thereby preparing a wet gel. A solution including the gel material, catalyst (gelation catalyst) and solvent will sometimes be referred to herein as a “gel material solution”. It should be noted that the catalyst may be omitted.

Hereinafter, it will be described in further detail how to prepare a wet gel using silica, for example.

A material solution of silica is subjected to a sol-gel reaction, thereby synthesizing silica fine particles, which are then gelled in a solvent to obtain a wet gel. The silica fine particles are formed by making the material react in the solution and then assemble together, thereby forming a solid skeleton with a network structure. More particularly, the composition of the material, which is a predetermined solid component, and that of the solvent are determined. A solution that has been prepared to have a predetermined composition is stirred up with a catalyst or a viscosity control agent added thereto if necessary. Then, the solution is turned into a desired state of use by injecting or applying the solution. And by keeping the solution in such a state for a predetermined amount of time, the solution is gelled and turned into a wet gel. Optionally, an aging treatment may be performed as well to control the aging of the wet gel and the size and/or the distribution of the pores. The wet gel may be produced in the vicinity of room temperature, which is a normal working temperature, but may be heated if necessary. Even so, the wet gel is preferably formed at a temperature that is less than the boiling point of the solution.

As the material of silica, an alkoxysilane compound such as tetramethoxysilane, tetraethoxysilane, trimethoxymethyl-silane or dimethoxydimethylsilane, an oligomer compound thereof, a water glass compound such as sodium silicate (soda silicate) or potassium silicate, or colloidal silica may be used either by itself or as a mixture.

Any solvent may be used as long as the solvent can dissolve the material to produce silica. Water or a normal organic solvent such as methanol, ethanol, propanol, acetone, toluene or hexane may be used either by itself or as a mixture.

The catalyst may be a base catalyst and/or an acid catalyst. Specifically, the catalyst may be water, an acid such as hydrochloric acid, sulfuric acid or acetic acid, or a base such as ammonium, pyridine, sodium hydroxide or potassium hydroxide.

Examples of preferred viscosity control agents include ethyleneglycol, glycerol, polyvinylalcohol, and silicone oil. However, any other agent may also be used as long as that agent can change the wet gel into a desired shape of use.

If the porous body is used as a dry gel in the resultant nanoparticles-containing composite porous body, then the solid skeleton thereof may be subjected to some surface treatment to improve the reliability of the composite porous body in terms of its moisture resistance and the handiness when the surface affinity is changed. The surface treatment may be carried out on either the wet gel or on the dry gel obtained.

This surface treatment may be carried out by getting a chemical reaction caused by a surface treatment agent on the surface of the solid skeleton in the solvent of the wet gel. Examples of preferred surface treatment agents include: halogen-silane treatment agents such as trimethylchlorsilane, dimethyldichlorsilane, methyltrichlorsilane, ethyltrichlor-silane and phenyltrichlorsilane; alkoxy-silane treatment agents such as trimethylmethoxysilane, trimethylethoxysilane, dimethyldimethoxysilane, methyltriethoxysilane and phenyltri-ethoxysilane; silicone-silane treatment agents such as hexamethyldisiloxane and dimethylsiloxane oligomer; an amine-silane treatment agent such as hexamethyldisilazane; and alcohol treatment agents such as propyl alcohol, butyl alcohol, hexyl alcohol, octanol and decanol. An appropriate surface treatment agent may be selected according to the application.

Also, a carbon porous body can be used effectively as the porous body. The carbon porous body not only ensures good thermal resistance and chemical stability but also provides electrical conductivity as well. That is why the carbon porous body may be used as an electrode material, for example.

The carbon porous body can be obtained by forming a dry gel of a carbon precursor and then carbonizing the carbon precursor. First, a wet gel is prepared by gelling and stabilizing an organic polymer material while polymerizing the polymer material. Then, the wet gel is dried, thereby obtaining a dry gel (polymer gel) as a carbon precursor.

Any known polymer may be used as the organic polymer for the carbon precursor. Examples of preferred polymers include polyacrylonitrile, polyfurfuryl alcohol, polyimide, polyamide, polyurethane, polyurea, polyphenol and polyaniline. The materials of polyacrylonitrile, polyfurfuryl alcohol and polyaniline are acrylonitrile, furfuryl alcohol and aniline, respectively. Also, polyimide may be produced by a condensation polymerization reaction that forms an imide ring using a tetracarboxylic anhydride compound and a diamine compound, for example. Polyamide may be produced by a condensation polymerization reaction that forms an amide bond using a dicarboxylic acid compound or a dicarboxylic chloride compound and a diamine compound, for example. Also, polyurethane may be a diol compound such as polyol and a diisocyanate compound. Polyurea may be a diisocyanate compound. And polyphenol may be a phenol compound and an aldehyde compound. A polymer that easily advances the carbonization reaction is preferred. As such a polymer, a polymer including an aromatic component is preferred. Also, if necessary, any of these materials may react to a catalyst. Then, a polymer gel as a carbon precursor can be produced efficiently.

In polyphenol, for example, the phenol compound may be phenol, cresol, resorcinol (1,3-benzenediol), catechol, fluoroglycinol, a novolac-type phenol resin, a resol-type phenol resin, or a phenol carboxylate such as salicylic acid or oxybenzoic acid. Examples of preferred aldehyde compounds as the condensation agent include formaldehyde, acetaldehyde, furfural, paraformaldehyde that produces formaldehyde when heated, and hexamethylenetetraamine. As the condensation catalyst, a base catalyst and/or an acid catalyst may be used. The base catalyst mainly advances the addition reaction of a methylol group, for example, while the acid catalyst mainly advances the polyaddition condensation reaction such as a methylene bond. As the base catalyst, a normal catalyst for making a phenol resin, including hydroxides of alkaline metals such as sodium hydroxide and potassium hydroxide, carbonates of alkaline metals such as sodium carbonate and potassium carbonate, amine and ammonia, may be used. As the acid catalyst, sulfuric acid, hydrochloric acid, phosphoric acid, oxalic acid, acetic acid or trifluoroacetic acid may be used. Examples of preferred solvents include water, alcohols such as methanol, ethanol, propanol and butanol, and glycols such as ethyleneglycol and propyleneglycol, which may be used either by itself or as a mixture.

Next, the drying process of making a dry gel out of a wet gel having a solid skeleton with a network structure will be described.

As the drying process, a normal drying technique such as a natural drying technique, a heat drying technique or a low-pressure drying technique, a supercritical drying technique or a freeze-drying technique may be used. Generally speaking, if a dry gel should have a wide surface area and a low density, the amount of solid components in the wet gel should be reduced. Then, the gel strength will decrease. Also, according to a drying technique that just dries the object, the gel often shrinks due to a stress caused when the solvent vaporizes. For that reason, to make a dry gel with an excellent porous property out of a wet gel, the supercritical drying technique or freeze drying technique is preferably adopted as the drying technique. Then, it is possible to prevent the gel from shrinking during the drying process (i.e., increasing its density). Even in a normal drying method in which the solvent is vaporized, the shrinkage of the gel during the drying process can be minimized by using a solvent with a high boiling point to decrease the vaporization rate or by controlling the vaporization temperature. Alternatively, the shrinkage of the gel being dried may also be minimized even by subjecting the surface of solid components of the wet gel to a water-repellent process and controlling the surface tension thereof.

### Methods of Making Nanoparticles-Containing Composite Porous Body

Hereinafter, methods of making a nanoparticles-containing composite porous body according to a preferred embodiment of the present invention will be described. The methods of making a nanoparticles-containing composite porous body are roughly classifiable into a method in which composite particles are dispersed while a porous body is being made (which will be referred to herein as a “first type of manufacturing process”) and a method in which the composite particles are dispersed in a porous body that has been prepared in advance (which will be referred to herein as a “second type of manufacturing process”).

### First Type of Manufacturing Process

The first type of manufacturing process is further classifiable into two subtypes of manufacturing processes (which will be referred to herein as “manufacturing process 1-1” and “manufacturing process 1-2”, respectively).

The manufacturing process 1-1 includes the steps of: providing composite particles that include nanoparticles of an inorganic substance and organic aggregates coating the nanoparticles; preparing a material solution to make a porous body; mixing the material solution and the composite particles together; and making a porous body, which includes not only a solid skeleton and pores but also the composite particles that are dispersed, from the material solution.

The manufacturing process 1-2 includes the steps of: providing organic aggregates; preparing a material solution to make a porous body; mixing the material solution and the organic aggregates together; making a porous body, which includes not only a solid skeleton and pores but also the organic aggregates that are dispersed, from the material solution; and forming nanoparticles inside the organic aggregates included in the porous body.

In either case, the porous body is typically made by a sol-gel process and obtained as a wet gel. If necessary, a dry gel may be obtained by drying the wet gel.

By any of these methods, the nanoparticles-containing composite porous body 20 shown in FIG. 2 can be obtained. Alternatively, the organic aggregates or composite particles may be formed inside the solid skeleton of the porous body. As another alternative, by selecting an appropriate type of organic aggregates, a bond may be produced between the organic aggregates and the solid skeleton of a porous body.

Furthermore, the nanoparticles-containing composite porous body 10 shown in FIG. 1 may be obtained from the nanoparticles-containing composite porous body 20 shown in FIG. 2 and made by the first type of manufacturing process. That is to say, the nanoparticles-containing composite porous body 10 can be obtained by removing the organic aggregates 3 from the nanoparticles-containing composite porous body 20. The organic aggregates 3 may be removed by a pyrolysis reaction or oxidation reaction, for example. It should be noted that the organic aggregates 3 do not have to be removed completely but may be left partially if necessary.

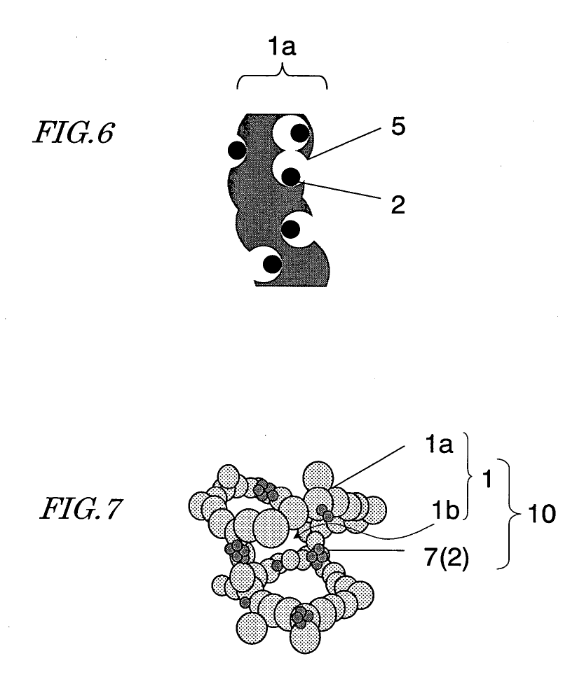

Also, if the organic aggregates 3 are decomposed in the structure in which the composite particles 4 are formed within the solid skeleton, then a structure in which vacancies 5 are created in the solid skeleton 1a can be obtained as schematically shown in FIG. 6. Even in such a structure, both physical coagulation of the nanoparticles 2 and their coagulation with time can be minimized. In addition, since spaces are created around the nanoparticles 2, high activity is achieved by utilizing the high specific surface of the nanoparticles 2 in an application in which the porous body is used in a chemical reaction. On top of that, since the porous body 1 itself has a high specific surface, the activity can be increased sufficiently if the porous body 1 itself has the function of converting catalyst activity or promoter activity.

As the method of removing the organic aggregates 3, a method of heating them to 300° C. or more is convenient because the pyrolysis reaction of the organic aggregates 3 usually starts to advance at a temperature of about 300° C. or more. From the standpoint of improving the efficiency in terms of work time, a temperature of 400° C. or more is preferred. The upper limit of the heating temperature may be at most equal to the thermal resistance temperature of the inorganic substance that makes the solid skeleton of the porous body. For example, if silica, an inorganic oxide, is used as the material of the solid skeleton of the porous body, the material tends to shrink at 1,000° C. or more. That is why the process is preferably carried out at less than 1,000° C. In that case, the atmosphere may be the air. Furthermore, in order not to have excessive heat generated by a combustion reaction, the process is preferably carried out within a low-concentration oxygen atmosphere. As used herein, the “low-concentration oxygen atmosphere” means an atmosphere with an oxygen concentration of 10% or less and includes an atmosphere with no oxygen at all. The process may also be carried out as a dry distillation process, a heating process within an inert atmosphere such as nitrogen or argon gas, or even a heating process within a vacuum.

Optionally, the organic aggregates may also be removed by oxidizing the aggregates. In that case, the organic aggregates are processed with ozone or hydrogen peroxide, for example. The ozone process may be carried out by using ozone that has been generated as a result of exposure to an ultraviolet ray, for instance.

### Second Type of Manufacturing Process

The second type of manufacturing process is further classifiable into two subtypes of manufacturing processes (which will be referred to herein as “manufacturing process 2-1” and “manufacturing process 2-2”, respectively).

The manufacturing process 2-1 includes the steps of: providing a solution containing composite particles that include nanoparticles of an inorganic substance and organic aggregates coating the nanoparticles; preparing a porous body including a solid skeleton and pores; and impregnating the porous body with the solution, thereby making the porous body have the composite particles dispersed.

The manufacturing process 2-2 includes the steps of: providing a solution containing organic aggregates; preparing a porous body including a solid skeleton and pores; impregnating the porous body with the solution, thereby making the porous body have the organic aggregates dispersed; and forming nanoparticles inside the organic aggregates included in the porous body.

As in the first type of manufacturing process, the porous body is typically made by a sol-gel process and obtained as a wet gel first in either case. If necessary, a dry gel may be obtained by drying the wet gel.

By this second type of manufacturing process, the nanoparticles-containing composite porous body 20 shown in FIG. 2 can be obtained. As already described for the first type of manufacturing process, the nanoparticles-containing composite porous body 10 may be obtained by removing the organic aggregates 3 from the nanoparticles-containing composite porous body 20. The organic aggregates 3 may be removed by a pyrolysis reaction or oxidation decomposition reaction, for example. It should be noted that the organic aggregates 3 do not have to be removed completely but may be left partially if necessary.

### Method of Making Nanoparticles-Containing Composite Porous Body with Carbon Porous Body

A nanoparticles-containing composite porous body with a carbon porous body may also be basically made by the first or second type of manufacturing process described above.

According to a manufacturing process, a nanoparticles-containing composite porous body can be obtained by dispersing composite particles in a carbon porous body that has been prepared in advance (as in the second type of manufacturing process described above). Furthermore, by removing the organic aggregates, a nanoparticles-containing composite porous body, in which nanoparticles are dispersed in the carbon porous body, may also be obtained.

According to another manufacturing process, a nanoparticles-containing composite porous body is obtained from a porous body, of which the solid skeleton is made of a carbon precursor (i.e., as a precursor composite porous body) by performing the process steps that have already been described for the first and second types of manufacturing processes, and then subjected to a carbonization process, thereby obtaining a nanoparticles-containing composite porous body in which nanoparticles are dispersed in a carbon porous body. In this method, if the organic aggregates or composite particles are mixed while the carbon precursor porous body is being made, then a nanoparticles-containing composite porous body with high activity, which achieves excellent homogenous dispersion and in which nanoparticles are dispersed within the solid skeleton of the porous body, can be obtained.

The process of carbonizing the carbon precursor is preferably carried out at 300° C. or more because the carbonization of the carbon precursor starts to advance at a temperature of about 300° C. From the standpoint of improving the efficiency in terms of work time, a temperature of 400° C. or more is preferred. The upper limit of the heating temperature may be at most equal to the thermal resistance temperature of the material of the nanoparticles. A carbon porous body, made of a carbon precursor dry gel with a network structure, carbonizes sufficiently up to the temperature of about 1,500° C. To carbonize the porous body with little shrinkage, the carbonization process is preferably carried out at less than 1,000° C. In that case, the atmosphere may be the air but is preferably a low-concentration oxygen atmosphere if the temperature needs to be set high. This is because combustion would occur if the temperature were raised to 500° C. or more.

The carbonization process may be carried out under substantially the same conditions as those for decomposing and removing the organic aggregates from the composite particles. Accordingly, in making a carbon nanoparticles-containing composite porous body, the carbonization process and the process of removing the organic aggregates can be carried out at the same time, thus improving the work efficiency significantly.

Also, the resultant carbon nanoparticles-containing composite porous body may be thermally treated at 1,000° C. or more such that the graphization of carbon is accelerated. Then, the porous body may be used as an electrode that needs to have electrical conductivity. Furthermore, if the porous body is exposed to an atmosphere of water vapor or carbon dioxide or subjected to an activation process using a chemical agent in order to increase the activity of carbon, then the specific surface can be further increased. Any of these post processes may be adopted according to the intended use of the nanoparticles-containing composite porous body.

An example of using organic aggregates that have been prepared in advance has been described for this preferred embodiment. Alternatively, a method in which organic aggregates are synthesized and dispersed within the porous body may also be adopted.

### EXAMPLES

Hereinafter, specific examples of the present invention will be described. However, the present invention is in no way limited to the following illustrative examples.

### Example 1

A nanoparticles-containing composite porous body was made by using a dry gel of silica as an inorganic oxide for the solid skeleton of the porous body and also using ferritin as the composite particle.

A solution was prepared as the material solution of silica so as to include tetramethoxysilane, ethanol and ammonia water (with a normality of 0.1) at a mole ratio of one to three to four. Then, ferritin was added at 0.1 mmol/L to the material solution. Ferritin had a diameter of about 12 nm and the core of ferritin included an iron oxide with a diameter of about 6 nm. This solution was put into a container and gelled at room temperature, thereby obtaining a solidified silica wet gel.

This wet gel was dried to obtain a nanoparticles-containing composite porous body A as a silica dry gel in which ferritin was dispersed. As the drying process, the solvent in this wet gel was replaced with acetone and then the wet gel was subjected to a supercritical drying process using carbon dioxide. The supercritical drying process was carried out at a pressure of 12 MPa and a temperature of 50° C. for four hours using carbon dioxide as a drying medium. Thereafter, the pressure was gradually lowered toward the atmospheric pressure and then the temperature was also decreased, thereby obtaining a dry gel. In this case, the size of the resultant dry gel was almost the same as that of the wet gel. That is to say, the wet gel hardly shrank.

Meanwhile, the nanoparticles-containing composite porous body A was thermally treated at 500° C. for an hour within a nitrogen atmosphere, thereby removing the protein as the organic aggregates of ferritin. In this manner, another nanoparticles-containing composite porous body B, in which an iron oxide was dispersed as the nanoparticles, was obtained.

Furthermore, the nanoparticles-containing composite porous body B was thermally treated at 700° C. for an hour within a hydrogen atmosphere, thereby obtaining another nanoparticles-containing composite porous body C, in which iron was dispersed as nanoparticles as a result of the reduction of the iron oxide. In this example, the iron oxide functions as the precursor of the iron particles.

### Comparative Example 1

To confirm the effects of Example No. 1, the following porous body and nanoparticles-containing composite porous body were obtained.

A porous body D of the silica dry gel was made under the same conditions as in Example No. 1 except that no ferritin was added in the process step of making the silica dry gel of Example No. 1.

Also, a nanoparticles-containing composite porous body E was obtained as a silica dry gel in which gold colloid was dispersed under the same conditions as in Example No. 1 except that the gold colloid with a diameter of about 4 nm was added at 0.1 mmol/L in the process step of making the silica dry gel of Example No. 1. The nanoparticles-containing composite porous body E was treated at 500° C. for an hour within a nitrogen atmosphere, thereby obtaining another nanoparticles-containing composite porous body F made of a silica dry gel in which gold colloid was dispersed.

Next, the results of comparison between Example No. 1 and Comparative Example No. 1 will be described. The dispersion of the nanoparticles in the respective nanoparticles-containing composite porous bodies was evaluated. The results are shown in the following Table 1:

TABLE 1

| | | Nitrogen | | Scanning electron | | | | |
|---|---|---|---|---|---|---|---|---|
| | | adsorption method | | microscope (SEM) | | Transmission electron | | |
| | | Specific | Pore | Porous | Nano- | microscope (TEM) | | |
| | | surface | diameter | body's | particles | Particle | Degree of | Closest |
| | Density | (by BET) | (by BJH) | network | dispersed | size | dispersion: | distance |
| | (kg/m³) | (m²/g) | (nm)* | structure | coagulated? | (nm) | coagulated? | (nm)** |
| Ex. 1: composite porous body A | 205 | 600 | 20 | Good | No | About 6 | Yes | About 12 |
| Ex. 1: composite porous body B | 220 | 700 | 18 | Good | No | About 6 | Yes | About 12 |
| Ex. 1: composite porous body C | 230 | 650 | 15 | Good | No | About 6 | Yes | About 11 |
| Cmp. Ex. 1: porous body D | 200 | 600 | 20 | Good | — | — | — | — |
| Cmp. Ex. 1: composite | 210 | 550 | 25 | Good | Yes | About | No | — |
| porous body E | | | | | | 4-40 | | |
| Cmp. Ex. 1: composite | 220 | 550 | 25 | Good | Yes | About | No | — |
| porous body F | | | | | | 4-40 | | |

*Pore diameter was measured using both adsorption and desorption.
**Closest distance was measured except overlapping portions.

The densities were estimated to confirm the samples as porous bodies. Each of these densities is an apparent density calculated based on the size and weight of its associated porous body. As can be seen, all nanoparticles-containing composite porous bodies had similar low densities. Thus, the solid skeleton of every silica dry gel, carrying the nanoparticles thereon, would have had almost the same degree of porous structure.

The porosity was evaluated by measuring a specific surface by a nitrogen adsorption method and also measuring the distribution of pores. An average pore diameter was obtained by calculating the specific surface by the BET method and by analyzing the distribution of pores by a Barret-Joyner-Halenda method (which will be referred to herein as a “BJH method”). In nanoparticles-containing composite porous bodies B and C, from which the organic aggregates were removed, a slight increase in specific surface was observed probably due to the creation of vacancies by the removal of the organic aggregates. It is believed that the little decrease in pore diameter was caused in these porous bodies by slight shrinkage during the heating process. In the conventional nanoparticles-containing composite porous bodies E and F, the specific surface and pore diameter changed probably due to the influence of the gold colloid dispersed.

The state of the network solid skeleton structure of the porous body and the dispersion state of the nanoparticles were observed through a scanning electron microscope (which will be abbreviated herein as “SEM”). The porous body was seen through the SEM at a zoom power of 50,000 without being processed particularly. As a result, the network solid skeleton structure was identified in every porous body. The coagulation of nanoparticles was not located clearly in nanoparticles-containing composite porous bodies A, B and C but was spotted clearly in nanoparticles-containing composite porous bodies E and F.

The particle sizes of the nanoparticles dispersed, the degree of dispersion thereof, and the closest distance between them were estimated through a transmission electron microscope (which will be abbreviated herein as “TEM”). The zoom power of the TEM was adjusted from 100,000 times through 500,000 times. In the nanoparticles-containing composite porous body A, it was confirmed that the particle sizes of the nanoparticles dispersed were almost equal to the particle size of the ferritin core. The particle sizes remained the same in the nanoparticles-containing composite porous bodies B and C, which were obtained by thermally treating the nanoparticles-containing composite porous body A. As a result of these TEM observations, particles of almost equal sizes were dispersed as single particles except where the nanoparticles seemed to overlap each other when seen through the microscope, and no big coagulation was spotted. Also, the closest distance between those particles was almost equal to the size of ferritin as spherical organic aggregates. Thus, it was believed that the organic aggregates minimized the coagulation of nanoparticles and produced homogenous dispersion. Furthermore, a lot of nanoparticles were present within the solid skeleton.

The particles present could not be clearly spotted through the electron microscope because the difference in mass number between silicon in the solid skeleton component and carbon in the organic aggregates was small. However, their presence is deduced because the specific surface increased as a result of the heat treatment and because the closest distance between the nanoparticles was almost equal to the size of the organic aggregates.

### Example 2

A nanoparticles-containing composite porous body was made by using a silica dry gel as the solid skeleton of the porous body and also using a dendrimer, including palladium particles, as the composite particle.

A solution was prepared as the material solution of silica so as to include tetramethoxysilane, ethanol and ammonia water (with a normality of 0.1) at a mole ratio of one to three to four. Then, dendrimer including palladium particles was added at 0.1 mmol/L to the material solution. This solution was put into a container and gelled at room temperature, thereby obtaining a solidified silica wet gel.

It should be noted that the dendrimer including the palladium particles was a fourth-generation polypropylene-imine dendrimer. The dendrimer had a diameter of about 4.5 nm, the palladium particles included had a diameter of about 2.4 nm, and the surface group was amino group. The surface reacted to tetramethoxysilane, which is the material of silica, and was chemically bonded to silica.

This wet gel was dried to obtain a nanoparticles-containing composite porous body G as a silica dry gel in which dendrimer composite particles were dispersed. As the drying process, the solvent in this wet gel was replaced with acetone and then the wet gel was subjected to a supercritical drying process using carbon dioxide. The supercritical drying process was carried out at a pressure of 12 MPa and a temperature of 50° C. for four hours using carbon dioxide as a drying medium. Thereafter, the pressure was gradually lowered toward the atmospheric pressure and then the temperature was also decreased, thereby obtaining a dry gel. In this case, the size of the resultant dry gel was almost the same as that of the wet gel. That is to say, the wet gel hardly shrank.

Meanwhile, the nanoparticles-containing composite porous body G was thermally treated at 500° C. for an hour within a nitrogen atmosphere, thereby removing the dendrimer as the organic aggregates. In this manner, another nanoparticles-containing composite porous body H, in which palladium particles were dispersed as the nanoparticles, was obtained.

Next, the results of comparison between Example No. 2 and Comparative Example No. 1 will be described. As in Example No. 1, the dispersion of the nanoparticles in the respective nanoparticles-containing composite porous bodies was evaluated. The results are shown in the following Table 2:

TABLE 2

| | | Nitrogen | | Scanning electron | | | | |
|---|---|---|---|---|---|---|---|---|
| | | adsorption method | | microscope (SEM) | | Transmission electron | | |
| | | Specific | Pore | Porous | Nano- | microscope (TEM) | | |
| | | surface | diameter | body's | particles | Particle | Degree of | Closest |
| | Density | (by BET) | (by BJH) | network | dispersed | size | dispersion: | distance |
| | (kg/m³) | (m²/g) | (nm)* | structure | coagulated? | (nm) | coagulated? | (nm)** |
| Ex. 2: composite porous | 210 | 600 | 20 | Good | No | About | Yes | About 4 |
| body G | | | | | | 2.5 | | |
| Ex. 2: composite porous | 210 | 700 | 18 | Good | No | About | Yes | About 4 |
| body H | | | | | | 2.4 | | |
| Cmp. Ex. 1: porous body D | 200 | 600 | 20 | Good | — | — | — | — |
| Cmp. Ex. 1: composite | 210 | 550 | 25 | Good | Yes | About | No | — |
| porous body E | | | | | | 4-40 | | |
| Cmp. Ex. 1: composite | 220 | 550 | 25 | Good | Yes | About | No | — |
| porous body F | | | | | | 4-40 | | |

*Pore diameter was measured using both adsorption and desorption.
**Closest distance was measured except overlapping portions.

The densities were estimated to confirm the samples as porous bodies. Each of these densities was calculated based on the size and weight of its associated porous body. As can be seen, all nanoparticles-containing composite porous bodies had similar low densities. Thus, the solid skeleton of every silica dry gel, carrying the nanoparticles thereon, would have had almost the same degree of porous structure.

The porosity was evaluated by measuring a specific surface by a nitrogen adsorption method and also measuring the distribution of pores. An average pore diameter was obtained by calculating the specific surface by the BET method and by analyzing the distribution of pores by the BJH method. In nanoparticles-containing composite porous body H, from which the organic aggregates were removed, a slight increase in specific surface was observed probably due to the creation of vacancies by the removal of the organic aggregates.

The state of the network solid skeleton structure of the porous body and the dispersion state of the nanoparticles were observed through an SEM. The porous body was seen through the SEM at a zoom power of 50,000 without being processed particularly. As a result, the network solid skeleton structure was identified in every porous body as in the first example. The coagulation of nanoparticles was not located clearly in nanoparticles-containing composite porous bodies G and H but the coagulation of gold colloid was spotted clearly in nanoparticles-containing composite porous bodies E and F.

The particle sizes of the nanoparticles dispersed, the degree of dispersion thereof, and the closest distance between them were estimated through a TEM. The zoom power of the TEM was adjusted from 100,000 times through 500,000 times. In the nanoparticles-containing composite porous body G, it was confirmed that the particle sizes of the nanoparticles dispersed were almost equal to the particle size of palladium particles in the dendrimer. The particle sizes remained the same in the nanoparticles-containing composite porous body H, which was obtained by thermally treating the nanoparticles-containing composite porous body G. As a result of these TEM observations, particles of almost equal sizes were dispersed as single particles except where the nanoparticles seemed to overlap each other when seen through the microscope, and no big coagulation was spotted. Also, the closest distance between those particles was smaller than the size of the dendrimer as spherical organic aggregates. However, it was discovered that the coagulation of the nanoparticles was minimized. Furthermore, a lot of nanoparticles were present within the solid skeleton.

### Example 3

A nanoparticles-containing composite porous body was made by using a carbon precursor dry gel as the solid skeleton of the porous body and also using a dendrimer, including platinum particles, as the composite particle.

A solution was prepared using water as a solvent so as to include resorcinol (0.3 mol/L), formaldehyde and sodium carbonate at a mole ratio of 1 to 2 to 0.01. The solution was left at about 80° C. for four days, thereby forming a carbon precursor wet gel of a polyphenol polymer. Then, dendrimer including platinum nanoparticles was added at 0.1 mmol/L to the material solution. It should be noted that the dendrimer including the platinum nanoparticles was a fourth-generation polyamideamine dendrimer. The dendrimer had a diameter of about 4.5 nm, the platinum particles included had a diameter of about 1.5 nm, and the surface group was hydroxyl group.

This wet gel was dried to obtain a nanoparticles-containing composite porous body I as a carbon precursor dry gel in which dendrimer composite particles were dispersed. As the drying process, the water in this wet gel was replaced with acetone and then the wet gel was subjected to a supercritical drying process using carbon dioxide. The supercritical drying process was carried out at a pressure of 12 MPa and a temperature of 50° C. for four hours using carbon dioxide as a drying medium. Thereafter, the pressure was gradually lowered toward the atmospheric pressure and then the temperature was also decreased, thereby obtaining a dry gel. In this case, the size of the resultant dry gel was almost the same as that of the wet gel. That is to say, the wet gel hardly shrank.

Meanwhile, the nanoparticles-containing composite porous body I was thermally treated at 200° C. for an hour, at 300° C. for an hour, and then at 600° C. for an hour within a nitrogen atmosphere, thereby removing the dendrimer as the organic aggregates. In this manner, another nanoparticles-containing composite porous body J, in which platinum nanoparticles were dispersed and of which the solid skeleton of the carbon precursor was carbonized, was obtained.

### Comparative Example 2

To confirm the effects of Example No. 3, the following porous body and nanoparticles-containing composite porous body were obtained.

A porous body K of the carbon precursor dry gel was made under the same conditions as in Example No. 3 except that no dendrimer was added in the process step of making the carbon precursor dry gel of Example No. 3.

Also, another porous body L was obtained by thermally treating this carbon precursor dry gel under the conditions adopted in Example No. 3.

Furthermore, a nanoparticles-containing composite porous body M was obtained as a carbon porous body in which gold colloid was dispersed by obtaining the carbon precursor dry gel under the same conditions as in Example No. 3 except that the gold colloid with a diameter of about 4 nm was added at 0.1 mmol/L in the process step of making the carbon precursor dry gel of Example No. 3 and then thermally treating the dry gel under the conditions adopted in Example No. 3.

Next, the results of comparison between Example No. 3 and Comparative Example No. 2 will be described. The dispersion of the nanoparticles in the respective nanoparticles-containing composite porous bodies was evaluated. The results are shown in the following Table 3:

TABLE 3

| | | Nitrogen | | Scanning electron | | | | |
|---|---|---|---|---|---|---|---|---|
| | | adsorption method | | microscope (SEM) | | Transmission electron | | |
| | | Specific | Pore | Porous | Nano- | microscope (TEM) | | |
| | | surface | diameter | body's | particles | Particle | Degree of | Closest |
| | Density | (by BET) | (by BJH) | network | dispersed | size | dispersion: | distance |
| | (kg/m³) | (m²/g) | (nm)* | structure | coagulated? | (nm) | coagulated? | (nm)** |
| Ex. 3: composite porous | 160 | 650 | 18 | Good | No | About | Yes | About 4 |
| body I | | | | | | 1.5 | | |
| Ex. 3: composite porous | 130 | 780 | 16 | Good | No | About | Yes | About 3 |
| body J | | | | | | 1.4 | | |
| Cmp. Ex. 2: porous body K | 150 | 650 | 18 | Good | — | — | — | — |
| Cmp. Ex. 2: porous body L | 120 | 800 | 15 | Good | — | — | — | — |
| Cmp. Ex. 2: composite | 130 | 750 | 18 | Good | Yes | About | No | — |
| porous body M | | | | | | 4-40 | | |

*Pore diameter was measured using both adsorption and desorption.
**Closest distance was measured except overlapping portions.

The densities were estimated to confirm the samples as porous bodies. Each of these densities was calculated based on the size and weight of its associated porous body. As can be seen, all nanoparticles-containing composite porous bodies had similar low densities. The nanoparticles-containing composite porous body I and the porous body K that had not been carbonized yet had almost the same values, while the nanoparticles-containing composite porous bodies J and M and porous body K that had been carbonized and turned into carbon also had almost the same values. Thus, it was discovered that when made under the same conditions, the porous body portions had substantially the same structures.

The porosity was evaluated by measuring a specific surface by a nitrogen adsorption method and also measuring the distribution of pores. An average pore diameter was obtained by calculating the specific surface by the BET method and by analyzing the distribution of pores by the BJH method. Unlike the first and second examples in which the porous body is a silica dry gel, the samples that had been heated for the purpose of carbonization had low densities and high specific surfaces. These results were obtained probably because the effect caused by the creation of vacancies due to the removal of the organic aggregates and the effect caused by the pyrolysis and carbonization of the solid skeleton enhanced each other.

The state of the network solid skeleton structure of the porous body and the dispersion state of the nanoparticles were observed through an SEM. The porous body was seen through the SEM at a zoom power of 50,000 without being processed particularly. As a result, the network solid skeleton structure was identified in every porous body as in the first and second examples. The coagulation of nanoparticles was not located clearly in nanoparticles-containing composite porous bodies I and J but the coagulation of gold colloid was spotted clearly in nanoparticles-containing composite porous body M.

The particle sizes of the nanoparticles dispersed, the degree of dispersion thereof, and the closest distance between them were estimated through a TEM. The zoom power of the TEM was adjusted from 100,000 times through 500,000 times. In the nanoparticles-containing composite porous bodies I and J, it was confirmed that the particle sizes of the nanoparticles dispersed were almost equal to the particle size of platinum particles in the dendrimer. As a result of these TEM observations, particles of almost equal sizes were dispersed as single particles except where the nanoparticles seemed to overlap each other when seen through the microscope, and no big coagulation was spotted. Also, the closest distance between those particles was smaller than the size of the dendrimer as spherical organic aggregates. However, it was discovered that the coagulation of the nanoparticles was minimized. Furthermore, a lot of platinum nanoparticles were present within the solid skeleton.

### Example 4

A nanoparticles-containing composite porous body was made by using a silica dry gel as the solid skeleton of the porous body, a dendrimer, including no nanoparticles, as the organic aggregates, and platinum particles as the nanoparticles, respectively.

A solution was prepared as the material solution of silica so as to include tetramethoxysilane, ethanol and ammonia water (with a normality of 0.1) at a mole ratio of one to three to four. Then, a fourth-generation polyamideamine dendrimer having a hydroxyl group on its surface was added at 0.2 mmol/L to the material solution. This solution was put into a container and gelled at room temperature, thereby obtaining a solidified silica wet gel in which the dendrimer was dispersed in the solid skeleton. It should be noted that the fourth-generation polyamideamine dendrimer had a diameter of about 4.5 nm, and the hydroxyl group on the surface reacted to tetramethoxysilane, which is the material of silica, and was chemically bonded to silica.

This silica wet gel was impregnated with a 3 mmol/L ethanol solution of chloroplatinate for one day, thereby carrying a platinum base, which is the precursor of the platinum particles, in the dendrimer in the solid skeleton of the porous body. Then, sodium boron hydride was added to the gel at room temperature and the gel was reduced, thereby carrying platinum particles as a catalyst.

As the drying process, the solvent in this wet gel was replaced with acetone and then the wet gel was subjected to a supercritical drying process using carbon dioxide. The supercritical drying process was carried out at a pressure of 12 MPa and a temperature of 50° C. for four hours using carbon dioxide as a drying medium. Thereafter, the pressure was gradually lowered toward the atmospheric pressure and then the temperature was also decreased, thereby obtaining a nanoparticles-containing composite porous body as a silica dry gel in which the dendrimer including the platinum particles was dispersed. In this case, the size of the resultant dry gel was almost the same as that of the wet gel. That is to say, the wet gel hardly shrank.

It was confirmed that this nanoparticles-containing composite porous body had a network structure with an apparent density of about 210 kg/m³, a specific surface of about 600 m²/g and a pore diameter of about 20 nm and that the platinum nanoparticles had a diameter of about 2 nm and were dispersed homogenously without coagulating together.

This nanoparticles-containing composite porous body was further treated thermally at 500° C. for an hour within the air atmosphere, thereby removing the dendrimer as the organic aggregates and obtaining a nanoparticles-containing composite porous body in which the nanoparticles were dispersed. It was confirmed that the resultant nanoparticles-containing composite porous body had a network structure with an apparent density of about 210 kg/m³, a specific surface of about 650 m²/g and a pore diameter of about 20 nm and that the platinum nanoparticles had a diameter of about 2 nm and were dispersed homogenously without coagulating together. It should be noted that almost no carbon component was included in this nanoparticles-containing composite porous body.

### Example 5

A nanoparticles-containing composite porous body was made by using a silica dry gel as the solid skeleton of the porous body, apoferritin, which is ferritin including no core particles, as the organic aggregates, and platinum particles as the nanoparticles, respectively.

A solution was prepared as the material solution of silica so as to include tetramethoxysilane, ethanol and ammonia water (with a normality of 0.1) at a mole ratio of one to three to four. The solution was gelled at room temperature, thereby obtaining a silica wet gel. Then, this wet gel was impregnated with a pH7 buffer solution including apoferritin at a concentration of 0.5 mmol/L at room temperature for two days. Thereafter, the silica wet gel in which apoferritin was dispersed was impregnated with a 3 mmol/L ethanol solution of chloroplatinate ammonium for one day, thereby carrying a platinum base, which is the precursor of the platinum particles, in apoferritin.

The solvent in this wet gel was replaced with acetone and then the wet gel was subjected to a supercritical drying process using carbon dioxide. The supercritical drying process was carried out at a pressure of 12 MPa and a temperature of 50° C. for four hours using carbon dioxide as a drying medium. Thereafter, the pressure was gradually lowered toward the atmospheric pressure and then the temperature was also decreased, thereby obtaining a nanoparticles-containing composite porous body as a silica dry gel in which apoferritin including a platinum base was dispersed.

It was confirmed that this nanoparticles-containing composite porous body had a network structure with an apparent density of about 210 kg/m³, a specific surface of about 650 m²/g and a pore diameter of about 20 nm.

This nanoparticles-containing composite porous body was further treated thermally at 500° C. for an hour within a hydrogen atmosphere, thereby removing the protein ferritin as the organic aggregates and obtaining a nanoparticles-containing composite porous body as a silica dry gel in which the platinum base was reduced into platinum nanoparticles. It was confirmed that the resultant nanoparticles-containing composite porous body in which those platinum nanoparticles were dispersed had a network structure with an apparent density of about 230 kg/m³, a specific surface of about 600 m²/g and a pore diameter of about 20 nm and that the platinum nanoparticles dispersed had a diameter of about 5 nm and hardly coagulated together.

### Example 6

A nanoparticles-containing composite porous body was made by using a carbon precursor dry gel as the solid skeleton of the porous body, a dendrimer as the organic aggregates of the composite particles, and manganese oxide particles as the nanoparticles of the composite particles, respectively.

First, a solution was prepared using water as a solvent so as to include resorcinol (0.3 mol/L), formaldehyde and sodium carbonate at a mole ratio of 1 to 2 to 0.01. The solution was left at about 80° C. for four days, thereby forming a carbon precursor wet gel of a polyphenol polymer. Then, the wet gel thus obtained was impregnated with a 1 mmol/L ethanol solution of a fourth-generation polyamideamine dendrimer having a hydroxyl group including manganese oxide particles on its surface. This solution was left at room temperature for one week, thereby obtaining a wet gel of a nanoparticles-containing composite porous body in which the dendrimer was dispersed in the porous body solid skeleton of the carbon precursor.

As the drying process, the solvent in this wet gel was replaced with acetone and then the wet gel was subjected to a supercritical drying process using carbon dioxide. The supercritical drying process was carried out at a pressure of 12 MPa and a temperature of 50° C. for four hours using carbon dioxide as a drying medium. Thereafter, the pressure was gradually lowered toward the atmospheric pressure and then the temperature was also decreased, thereby obtaining a nanoparticles-containing composite porous body as a silica dry gel in which the dendrimer including platinum particles was dispersed.

It was confirmed that this nanoparticles-containing composite porous body had a network structure with an apparent density of about 150 kg/m³, a specific surface of about 700 m²/g and a pore diameter of about 18 nm and that the manganese oxide nanoparticles had a diameter of about 3 nm and were dispersed homogenously without coagulating together.

This nanoparticles-containing composite porous body was further subjected to a carbonization process at 200° C. for one hour, at 300° C. for another hour, at 600° C. for one more hour and at 800° C. for one more hour within a nitrogen atmosphere, thereby removing the dendrimer as the organic aggregates and obtaining a nanoparticles-containing composite porous body in which the nanoparticles were dispersed. It was confirmed that the resultant nanoparticles-containing composite porous body had a network structure with an apparent density of about 120 kg/m³, a specific surface of about 700 m²/g and a pore diameter of about 16 nm and that the manganese oxide nanoparticles had a diameter of about 3 nm and were dispersed homogenously without coagulating together. In this case, the closest distance between nanoparticles was about 3 nm.

### Example 7

Example No. 6 was modified such that the carbon precursor wet gel was impregnated with a 1 mmol/L ethanol solution including a fourth-generation polyamideamine dendrimer having a hydroxyl group including manganese oxide particles on its surface and the same type of dendrimer with no manganese oxide particles at a one to one ratio. This solution was left at room temperature for one week, thereby obtaining a wet gel of a nanoparticles-containing composite porous body in which the dendrimer was dispersed in the porous body solid skeleton of the carbon precursor. Next, this wet gel was dried and then subjected to a carbonization process under the same conditions, thereby obtaining a nanoparticles-containing composite porous body.

The carbon porous body including these manganese oxide particles had substantially the same physical property values as those of Example No. 6 and the nanoparticles also had almost the same diameter of 3 nm. However, it was confirmed that the closest distance between the nanoparticles expanded to about 5 nm. This adjustment may have been made due to the presence of the dendrimer including no nanoparticles.

### Example 8

A nanoparticles-containing composite porous body was made by using a silica dry gel as the solid skeleton of the porous body, a dendrimer, including no nanoparticles, as the organic aggregates, and titanium oxide particles and platinum particles as the nanoparticles, respectively.

A solution was prepared as the material solution of silica so as to include tetramethoxysilane, ethanol and ammonia water (with a normality of 0.1) at a mole ratio of one to three to four. Then, a fourth-generation polyamideamine dendrimer having a hydroxyl group, including titanium oxide particles, on its surface was added at 0.2 mmol/L to the material solution. This solution was gelled at room temperature, thereby obtaining a silica wet gel in which the dendrimer, including titanium oxide particles, was dispersed in the solid skeleton. It should be noted that the fourth-generation polyamideamine dendrimer had a diameter of about 4.5 nm, the titanium oxide particles thereof had a diameter of about 2 nm and the hydroxyl group on the surface reacted to tetramethoxysilane, which is the material of silica, and was chemically bonded to silica.

This silica wet gel was impregnated with a 3 mmol/L ethanol solution of chloroplatinate for five hours, thereby carrying a platinum base, which is the precursor of the platinum particles, in the dendrimer in the solid skeleton of the porous body. Then, sodium boron hydride was added to the gel at room temperature and the gel was reduced, thereby further producing platinum in the dendrimer.

This silica wet gel, in which the dendrimers including the titanium oxide particles and platinum particles were dispersed, was exposed to an ultraviolet ray after the solvent in the gel had been replaced with water. As a result, a gas was emitted from this porous body. The gas included hydrogen, which was believed to have functioned as a catalyst for the photolysis of water.

This wet gel was dried as in the other examples described above. As a result, it was confirmed that this wet gel had a network structure with an apparent density of about 210 kg/m³, a specific surface of about 600 m²/g and a pore diameter of about 20 nm and that most of the nanoparticles produced were composite particles in which smaller platinum particles deposited on the homogenously dispersed titanium oxide particles with a diameter of about 2 nm.

### Example 9

A nanoparticles-containing composite porous body was made by using a titania dry gel as the solid skeleton of the porous body and a dendrimer, including palladium particles, as the composite particle, respectively.

A solution was prepared as the material solution of titania so as to include titanium isopropoxide, isopropyl alcohol and hydrochloric acid at a mole ratio of one to five to four. Then, a dendrimer was added at 0.5 mmol/L to the material solution. This solution was gelled at room temperature, thereby obtaining a titania wet gel. It should be noted that the dendrimer used was a fourth-generation polypropyleneimine dendrimer with a diameter of about 4.5 nm and with an amino group on its surface, and the amino group on the surface reacted to, and was chemically bonded to, titanium isopropoxide.

This wet gel was impregnated with a 3 mmol/L ethanol solution of sodium palladium chloride for one day, thereby carrying a palladium base, which is the precursor of the palladium particles, in the dendrimer. Then, potassium boron hydride was added to the gel at room temperature and the gel was reduced, thereby producing palladium particles. Next, the wet gel was dried as in the other examples, thereby obtaining a nanoparticles-containing composite porous body as a titania dry gel in which the dendrimer composite particles were dispersed.

This nanoparticles-containing composite porous body was treated thermally at 600° C. for an hour within a nitrogen atmosphere, thereby turning titania, forming the solid skeleton of the network structure, into poly-crystals, removing the dendrimer as the organic aggregates, and obtaining a nanoparticles-containing composite porous body in which palladium particles were dispersed as the nanoparticles. It was confirmed that the resultant nanoparticles-containing composite porous body had a network structure with an apparent density of about 300 kg/m³, a specific surface of about 300 m²/g and a pore diameter of about 10 nm and that the palladium particles had a diameter of about 2 nm and were dispersed homogenously without coagulating together.

This nanoparticles-containing composite porous body was put into a sealed container with a quartz window, which was then filled with the air including NOₓ. When the air inside this container was exposed to an ultraviolet ray through the quartz window, it was confirmed that the concentration of NOₓ in the container decreased and that the porous body functioned as a photocatalyst.

### Example 10

A nanoparticles-containing composite porous body was made by using a carbon precursor dry gel as the solid skeleton of the porous body and also using a dendrimer, including palladium particles, as the composite particle.

A solution was prepared using water as a solvent so as to include resorcinol (0.3 mol/L), formaldehyde and sodium carbonate at a mole ratio of 1 to 2 to 0.01. The solution was left at about 80° C. for four days, thereby forming a carbon precursor wet gel of a polyphenol polymer. Then, dendrimer including palladium particles was added at 1 mmol/L to the material solution. This solution was gelled to obtain a carbon precursor wet gel. It should be noted that the dendrimer including the palladium particles was a fourth-generation polypropyleneimine dendrimer. The dendrimer had a diameter of about 4.5 nm, and the palladium particles included had a diameter of about 2.4 nm.

This wet gel was dried to obtain a nanoparticles-containing composite porous body as a carbon precursor dry gel in which dendrimer composite particles were dispersed. As the drying process, the water in this wet gel was replaced with acetone and then the wet gel was subjected to a supercritical drying process using carbon dioxide. The supercritical drying process was carried out at a pressure of 12 MPa and a temperature of 50° C. for four hours using carbon dioxide as a drying medium. Thereafter, the pressure was gradually lowered toward the atmospheric pressure and then the temperature was also decreased, thereby obtaining a dry gel. In this case, the size of the resultant dry gel was almost the same as that of the wet gel. That is to say, the wet gel hardly shrank.

This nanoparticles-containing composite porous body was further treated thermally at 200° C. for one hour, at 300° C. for another hour, and at 600° C. for one more hour within a nitrogen atmosphere, thereby removing the dendrimer as the organic aggregates and obtaining a nanoparticles-containing composite porous body in which the solid skeleton made of the carbon precursor was carbonized and in which palladium particles were dispersed. It was confirmed that this porous body had a network structure with an apparent density of about 120 kg/m³, a specific surface of about 700 m²/g and a pore diameter of about 15 nm and that the palladium particles had a diameter of about 2.4 nm and were dispersed homogenously without coagulating together.

The resultant carbon nanoparticles-containing composite porous body was pulverized and then mixed with Nafion of a fluorine polymer electrolyte with a sulfonic acid group. The mixture was then applied onto both sides of a Nafion film of a solid polymer electrolyte, thereby making an electrochemical element with electrodes. Hydrogen was introduced into one side of this electrochemical element and the air was introduced into the opposite side to obtain a fuel cell. The output voltage measured 0.8 V between the electrodes at the two terminals. Thus, it was confirmed that the porous body operated as a catalyst at the electrodes.

The present invention provides a nanoparticles-containing composite porous body in which nanoparticles with a high specific surface and a high degree of activity are carried on a porous body with a high specific surface without deteriorating their properties.

The nanoparticles-containing composite porous body of the present invention includes nanoparticles that are dispersed homogenously, and therefore, can be used effectively as a catalyst or an electrode without losing its activity. That is why the porous body is applicable for use in an electrochemical element including such a catalyst or electrode such as a fuel cell, an air cell, a water electrolytic device, an electrical double layer capacitor, a gas sensor or a contamination gas exhaust system, for example. In addition, since the nanoparticles are dispersed homogenously without coagulating together, the porous body can be used extensively in light-emitting, light-modulating and other optical devices and electronic devices by utilizing the property of those nanoparticles.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention that fall within the true spirit and scope of the invention.

What is claimed is:

1. A nanoparticles-containing composite porous body comprising:
a porous body made of a dry gel, which has a pore ratio of 50% or more and which includes a solid skeleton and pores;
nanoparticles of an inorganic substance; and
organic aggregates made of a dendritic polymer,
wherein the nanoparticles are carried on the solid skeleton without coagulating together or being chemically bonded to the skeleton, and
wherein the organic aggregates coat the nanoparticles, thereby making composite particles, and
wherein the nanoparticles are carried on the solid skeleton by way of the organic aggregates.

2. The nanoparticles-containing composite porous body of claim 1, wherein the nanoparticles are carried inside the solid skeleton.

3. The nanoparticles-containing composite porous body of claim 2, wherein the organic aggregates are chemically bonded to the solid skeleton.

4. The nanoparticles-containing composite porous body of claim 2, wherein the organic aggregates have an ordered structure.

5. The nanoparticles-containing composite porous body of claim 4, wherein the organic aggregates are spherical organic aggregates.

6. The nanoparticles-containing composite porous body of claim 1, wherein the dendritic polymers are dendrimers.

7. The nanoparticles-containing composite porous body of claim 1, wherein the solid skeleton of the porous body defines a network structure.

8. The nanoparticles-containing composite porous body of claim 7, wherein the porous body is a dry gel of an inorganic oxide.

9. The nanoparticles-containing composite porous body of claim 8, wherein the porous body is a carbon porous body.

10. A method of making a nanoparticles-containing composite porous body, the method comprising the steps of:
providing organic aggregates;
preparing a material solution to make a porous body;
mixing the material solution and the organic aggregates together;
making the porous body of a dry gel, which has a pore ratio of 50% or more and which includes a solid skeleton and pores, from the material solution, the porous body including the organic aggregates that are dispersed; and
forming nanoparticles inside the organic aggregates included in the porous body.

11. The method of claim 10, further comprising the step of drying the porous body,
wherein the solid skeleton of the porous body is made of a carbon precursor, and
wherein the method further comprises the step of forming a carbon porous body by carbonizing the carbon precursor after the step of drying has been performed.

12. The method of claim 10, further comprising the step of decomposing the organic aggregates included in the porous body.

13. The method of claim 10, wherein the step of forming the nanoparticles includes the steps of preparing a precursor of the nanoparticles and transforming the precursor into the nanoparticles.

14. A method of making a nanoparticles-containing composite porous body, the method comprising the steps of:
providing a solution containing composite particles that include nanoparticles of an inorganic substance and organic aggregates coating the nanoparticles;
preparing a porous body made of a dry gel, which has a pore ratio of 50% or more and which includes a solid skeleton and pores; and
impregnating the porous body with the solution, thereby making the porous body have the composite particles dispersed.

15. The method of claim 14, further comprising the step of drying the porous body,
wherein the solid skeleton of the porous body is made of a carbon precursor, and
wherein the method further comprises the step of forming a carbon porous body by carbonizing the carbon precursor after the step of drying has been performed.

16. The method of claim 14, further comprising the step of decomposing the organic aggregates included in the porous body.

17. A method of making a nanoparticles-containing composite porous body, the method comprising the steps of:
providing a solution containing organic aggregates;
preparing a porous body made of a dry gel, which has a pore ratio of 50% or more and which includes a solid skeleton and pores;
impregnating the porous body with the solution, thereby making the porous body have the organic aggregates dispersed; and
forming nanoparticles inside the organic aggregates included in the porous body.

18. The method of claim 17, further comprising the step of drying the porous body,
wherein the solid skeleton of the porous body is made of a carbon precursor, and
wherein the method further comprises the step of forming a carbon porous body by carbonizing the carbon precursor after the step of drying has been performed.

19. The method of claim 17, further comprising the step of decomposing the organic aggregates included in the porous body.

20. The method of claim 17, wherein the step of forming the nanoparticles includes the steps of preparing a precursor of the nanoparticles and transforming the precursor into the nanoparticles.

21. A nanoparticles-containing composite porous body made by the method of claim 10.

22. A nanoparticles-containing composite porous body made by the method of claim 14.

23. A nanoparticles-containing composite porous body made by the method of claim 17.
